(19) United States
(12) Patent Application Publication
(10) Pub. No.: US 2013/0180743 A1
(43) Pub. Date: Jul. 18, 2013

(54) Garden Row Hoe

(71) Applicant: Freddy Culley, Alton, VA (US)

(72) Inventor: Freddy Culley, Alton, VA (US)

(21) Appl. No.: 13/549,179

(22) Filed: Jul. 13, 2012

Related U.S. Application Data
(60) Provisional application No. 61/507,782, filed on Jul. 14, 2011.

(51) Int. Cl. A01C 5/06; A01B 3/24

(52) U.S. Cl. CPC A01C 5/062; A01B 3/24
USPC 172/697

(57) ABSTRACT

A garden row tool to till the soil may include a first longitudinal side frame support member, a second longitudinal side frame support member connected to the first longitudinal side frame member, a first blade and a second blade to connect to the first longitudinal side support member and the second longitudinal side support member to till the soil and a traverse frame support member to adjustably connect the first longitudinal side frame member and the second longitudinal side frame support member.

### PRIORITY

The present invention claims priority under 35 USC section 119 based on a provisional application which was filed on Jul. 14, 2011 with a Ser. No. of 61/507,782.

### FIELD OF THE INVENTION

The present invention relates to garden tools and more particularly to a garden tool to till and plow the soil.

### BACKGROUND

To make rows in gardens, gardeners may be required to use traditional tools, such as hoes, to dig up fresh soil. Utilizing hoes and other similar tools can be very laborious and tiresome, as gardeners may be required to dig and lilt soil in individual sections until each row is complete. This can cause gardeners to become very sore, and to develop aches and pains in their joints, necks, backs, and muscles. Additionally, this process can take hours, and may reduce the amount of time available for planting. An effective, convenient solution is necessary.

### SUMMARY

A garden row tool to till the soil may include a first longitudinal side frame support member, a second longitudinal side frame support member connected to the first longitudinal side frame member, a first blade and a second blade to connect to the first longitudinal side support member and the second longitudinal side support member to till the soil and a traverse frame support member to adjustably connect the first longitudinal side frame member and the second longitudinal side frame support member.

The first and second longitudinal side frame support member may include a threaded aperture to connect to the traverse frame support member and wherein the width between the first and second longitudinal side frame support member is adjustable by threading the traverse frame support member in the threaded aperture.

The blade may be connected to the longitudinal side frame support member by a plate.

The longitudinal side frame support member may be connected to a connector to connect to a tiller.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the garden row tool of the present invention;

FIG. 2 illustrates a side view of the garden row tool of the present invention;

FIG. 3 illustrates a back view of the garden row tool of the present invention;

FIG. 4 illustrates a side view of a cover for the garden row tool of the present invention;

FIG. 5 illustrates a bottom view of the garden row tool of the present invention;

FIG. 6 illustrates a side view of the blade of the garden row tool of the present invention;

FIG. 7 illustrates a perspective view of the longitudinal side frame support member of the garden row tool of the present invention;

FIG. 8 illustrates a perspective view of the traverse frame support member of the garden row tool of the present invention;

FIG. 9 illustrates an end view of the longitudinal side frame support member of the garden row tool of the present invention;

FIG. 10 illustrates an end view of the traverse frame support member;

FIGS. 11-13 illustrate connectors to a tiller;

FIGS. 14-18 illustrate the operation of the garden row tool of the present invention.

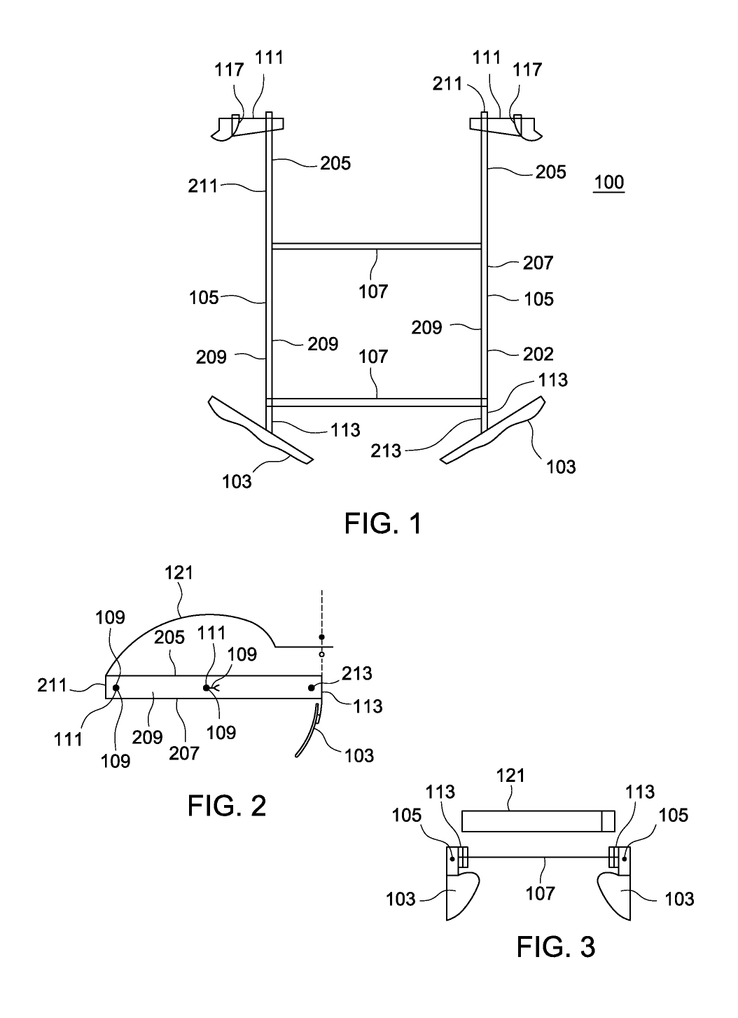

### DETAILED DESCRIPTION

The garden row hoe or garden row tool 100 may be designed to assist gardeners in efficiently creating rows suitable for planting seeds and plants. The garden row tool 100 may include a tool with an opposing blade 103 on opposing sides of the garden row tool 100. The users of the present invention may attach the garden row tool 100 to the back of any rear-tine tiller and pull the tiller as usual. As the tiller moves, the blades 103 may dig into the ground and lift out fresh dirt, preparing the soil for planting while creating neat and substantially rows in the soil. Additionally, the garden row tool 100 may be attached to and removed from tillers, allowing the garden row tool 100 to be instantly utilized and stored after use. The present invention may significantly reduce the time and effort necessary to create useable planting rows. The garden row tool 100 may provide consumers/gardeners with a simple and efficient way to instantly create useable planting rows. The present invention may include a pair of longitudinal side frame support members 105 which may be two substantially rectangular solid (or hollow) rails or parallel flat bars and which may be detachably connected to a pair of transverse frame support members 107 which may be a pair of threaded rods or two evenly-spaced, threaded horizontal bars. Each of the longitudinal side frame support members 105 may include a threaded port 111 position at the end of the longitudinal side frame support member 105 to cooperate or accept a bolt which may be inserted into the threaded port 111. The bolt may connect the garden row tool 100 of the present invention to the back of any rear-tine tiller (not shown). The longitudinal side frame support members 105 may be connected to a pair of vertical plates 113 at the opposing end of the longitudinal side frame support member 105 which may be connected to which shovel-shaped blades 103. The blades 103 may be positioned upright or at a downward-facing angle, allowing the blades 103 to scoop and lift soil while being maneuvered across the ground. Users may adjust the width of the present invention to accommodate different types of tillers by adjusting the longitudinal side frame support members 105 or flat bars closer together or farther apart to adjust the width of the garden row tool 100 on the threaded traverse frame support member 107 or horizontal bars. The traverse frame support member 107 may include female threads 111 positioned within an aperture 109 to cooperate with male threads 113 which may be positioned on ends of the traverse frame support member 107 (or the entire exterior surface of the traverse frame support member 107 may include the male threads 113). Once the appropriate width of the garden row tool 100 is achieved, the width of the longitudinal side frame support members 105 may be fixed or secured into place with a fastener such as nuts (not shown) placed on the female threads 113 on each side of the traverse frame support member 107 to secure the longitudinal side frame support member 105.

The longitudinal side frame support member 105, which may include a substantially rectangular cross-section, circular cross-section, and oval cross-section or other appropriate cross-section shape and which may extend the substantial length of the garden row tool 100, may include a front surface 211 which may be opposed to a back surface 213 and may be connected to a pair of opposing side surfaces 209, a top surface 205 and a bottom surface 207, the top surface 205 may be connected to the pair of opposing side surfaces 209, the front surface 211, and the back surface 213, the bottom surface 207 may be connected to the pair of opposing side surfaces 209, the front surface 211 and the back surface 213, the back front surface 213 may be connected to the top surface 205, the bottom surface 207, and the side surface 209, and the pair of side surfaces 209 may be connected to the top surface 205, the bottom surface 207, front surface 211 and the back surface 203.

The garden row tool 100 may include a vertical plate 113 to connect the blade 103 to the longitudinal side frame support member 105. Additionally, a connector 117 which may include a threaded port 111 to connect to the tiller (not shown) may be connected to the longitudinal side frame support member 105.

FIG. 2 illustrates a side view of the longitudinal side frame support member 105. FIG. 2 additionally illustrates a threaded aperture 109 which may include female threads 111 which may cooperate with male threads 113. The longitudinal side frame support member 105 may include a front surface 211 which may be opposed to a back surface 213 and may be connected to a pair of opposing side surfaces 209, a top surface 205 and a bottom surface 207, the top surface 205 may be connected to the pair of opposing side surfaces 209, the front surface 211, and the back surface 213, the bottom surface 207 may be connected to the pair of opposing side surfaces 209, the front surface 211 and the back surface 213, the back front surface 213 may be connected to the top surface 205, the bottom surface 207, and the side surface 209, and the pair of side surfaces 209 may be connected to the top surface 205, the bottom surface 207, front surface 211 and the back surface 203.

FIG. 2 additionally illustrates the vertical plate 113 which may connect to the back surface 213 and which may connect to the blade 103, and FIG. 2 illustrates a tine hood 121 to provide a cover for the garden row tool 100 which may include a curved portion and a substantially horizontal portion.

FIG. 3 illustrates a rearview of the garden row tool 100 and illustrates the tine hood 121 which may be positioned over the garden row tool 100 in order to protect the garden row tool 100 from weather. FIG. 3 illustrates that the plate 113 may be connected to the end of the longitudinal side frame member 105 and may be connected to the blade 103. A traverse frame support member 103 may extend to connect the pair of longitudinal side frame support members 105.

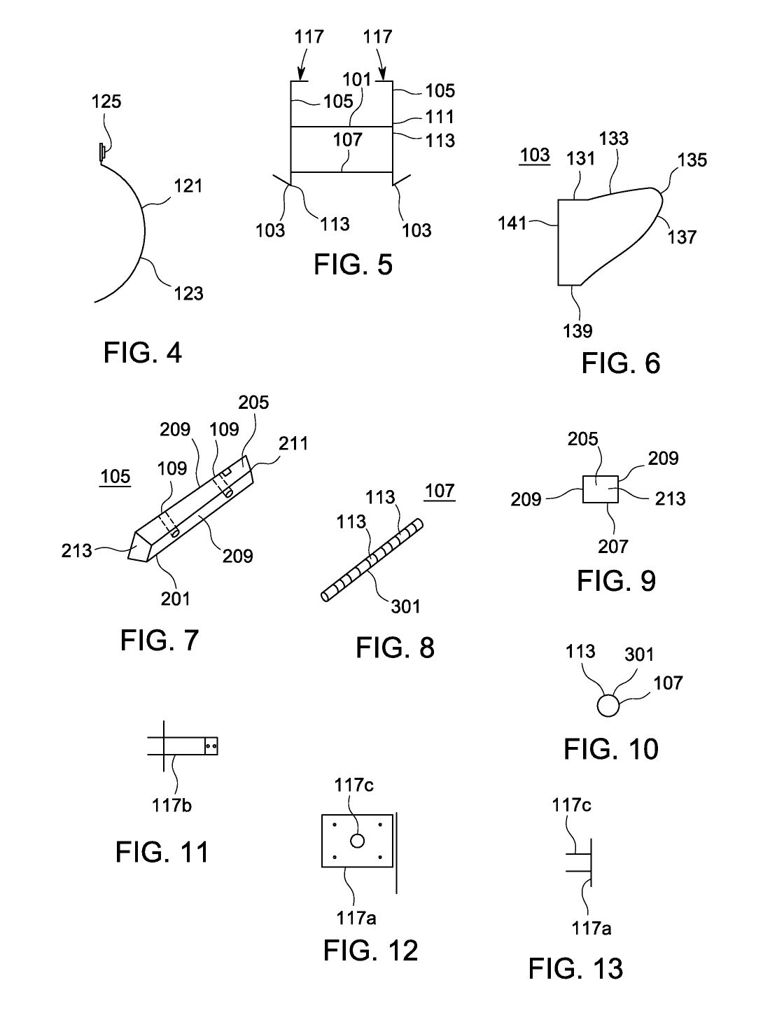

FIG. 4 illustrates the tine hood 121 which may include a curved portion 123 and a substantially horizontal portion 125.

FIG. 5 illustrates a bottom view of the garden row tool 100 which may include a pair of opposing longitudinal side frame support members 105 which may be adjustably connected by the traverse frame support member 107 which may be threadably connected to the longitudinal side frame members 105. The longitudinal side frame support member 105 may include an aperture 109 which may include female threads 111 which may cooperate with the male threads 113 which may be positioned at the end of the traverse frame support member 107. One end of the longitudinal side frame support member 105 may be connected to a plate 113 which may be connected to the blade 103 and an opposing end of the longitudinal side frame support member 105 may be connected to a connector 117 which may be connected to a tiller (not shown).

FIG. 6 illustrates a cross-section of the blade 103 which may include a substantial vertical surface 141 which may be connected to a first angled surface 131 which may be connected to a substantially horizontal surface 133 which may be connected to a convex surface 135 which may be connected to a curved surface 137 which may be connected to a second angled surface 139 which may be connected to the vertical surface 141.

FIG. 7 illustrates a perspective view of the longitudinal side frame support member 105. FIG. 7 additionally illustrates a threaded aperture 109 which may include female threads 111 which may cooperate with male threads 113. The longitudinal side frame support member 105 may include a front surface 211 which may be opposed to a back surface 213 and may be connected to a pair of opposing side surfaces 209, a top surface 205 and a bottom surface 207, the top surface 205 may be connected to the pair of opposing side surfaces 209, the front surface 211, and the back surface 213, the bottom surface 207 may be connected to the pair of opposing side surfaces 209, the front surface 211 and the back surface 213, the back front surface 213 may be connected to the top surface 205, the bottom surface 207, and the side surface 209, and the pair of side surfaces 209 may be connected to the top surface 205, the bottom surface 207, front surface 211 and the back surface 203.

FIG. 9 illustrates a back view of the elongated side frame support member 105 and illustrates the top surface 205, the bottom surface 207, the back surface 213 and the opposing side surfaces 209.

FIG. 8 illustrates a perspective view of the traverse frame support member 107 which may be a substantial cylinder which may include a outer cylinder surface 301 and may include male threads 113 which may extend over the entire cylinder surface 301 or a portion of the cylinder surface 301.

The traverse frame support number 107 may threadably cooperate with the threaded aperture 109.

FIG. 10 illustrates an end view of the traverse frame support member 107 which may be a substantial cylinder which may include an outer cylinder surface 301 and may include male threads 113 which may extend over the entire cylinder surface 301 or a portion of the cylinder surface 301.

FIGS. 11-13 illustrates connectors 117 to connect to a multitude of tillers. FIG. 11 illustrates connector 117b which may be a cylinder having a threaded aperture to connect to the tiller of a Troy Bilt (trademark) model HH-60-1050 79E and FIGS. 12 and 13 illustrates a front and side view of a cylinder 117c mounted on a plate 117a to connect to a Cub Cadet (trademark) model RT 65 tiller. The width of the garden row tool 100 may be enlarged or reduced (adjusted) to accommodate the size of the tractor which may tow the garden row tool 100.

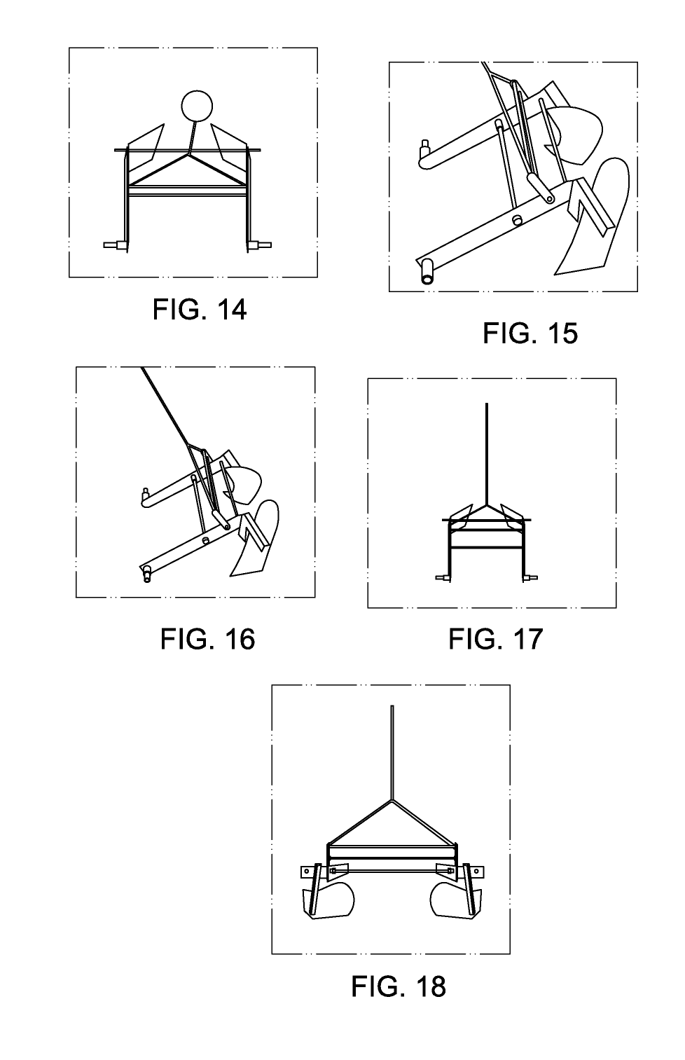

FIGS. 14-18 illustrates the operation of the garden row tool 100.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A garden row tool to till the soil, comprising:
a first longitudinal side frame support member;
a second longitudinal side frame support member connected to the first longitudinal side frame member;
a first blade and a second blade to connect to the first longitudinal side support member and the second longitudinal side support member to till the soil;
a traverse frame support member to adjustably connect the first longitudinal side frame member and the second longitudinal side frame support member.

2) A garden row tool to till the soil as in claim 1, wherein the first and second longitudinal side frame support member includes a threaded aperture to connect to the traverse frame support member and wherein the width between the first and second longitudinal side frame support member is adjustable by threading the traverse frame support member in the threaded aperture.

3) A garden row tool to till the soil as in claim 1, wherein the blade is connected to the longitudinal side frame support member by a plate.

4) A garden row tool to till the soil as in claim 1, wherein the longitudinal side frame support member is connected to a connector to connect to a tiller.
